(19) United States
(12) Patent Application Publication
(10) Pub. No.: US 2006/0005041 A1
(43) Pub. Date: Jan. 5, 2006

(54) System for identifying a person

(75) Inventors: Markus Cornelis Jakobus Lazeroms, Vroenhoven (BE); Johannes Johanna Van Herk, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/526,081

(22) PCT Filed: Sep. 1, 2003
(86) PCT No.: PCT/IB03/03991

§ 371 Date: Feb. 28, 2005

(30) Foreign Application Priority Data
Sep. 3, 2002 (EP) 02078614.1

(51) Int. Cl. H04K 1/00

(52) U.S. Cl. 713/186

(57) ABSTRACT

The invention relates to a system for identifying a person, comprising means for detecting a distribution of pressures, exerted by at least one foot (20) of the person on a surface, means for storing data of a number of persons, the data comprising a detected pressure distribution pattern (A,B,C) and an associated person identification code (X,Y,Z), and means for comparing a detected pressure distribution pattern (A) with stored pressure distribution patterns (A,B,C) until a match of pressure distribution patterns is found. The invention further relates to a method of identifying a person. The person is identified on the basis of a distribution of pressures, exerted by at least one of the feet (20) on a surface. When the user has placed one or both feet (20) on said surface, said distribution of pressures is detected. Subsequently, the detected pressure distribution pattern is compared with pressure distribution patterns stored in a storage medium, wherein each stored pressure distribution pattern is associated with a different user. As soon as a match of pressure distribution patterns is found, the identity of the user is known.

The present invention relates to a system for identifying a person.

The invention further relates to a method of identifying a person.

Systems for and methods of identifying a person are generally known. Such systems and methods are, for example, generally utilized in the field of weighing devices comprising a storage medium for storing weight data In order to make such weighing devices suitable for use by a group of users, the weight data are labelled with specific user identification codes associated with the individual members of the group. In this way, interference of the weight data of the individual members is avoided, and each member is able to retrieve his own stored data. The storage medium of the weighing device may be a relatively simple memory bank with a few different registers in which the data are stored. Without any security measures, every user has access to the stored data in every register. Therefore, in situations in which it is important to respect the privacy of the individual users, the storage medium needs to be secured. For this purpose, according to the state of the art, fingerprint recognition or identification by means of personal identification codes is often used. In order for a user to be able to retrieve his own stored data, he needs to establish his identity, in the first case by positioning a fingertip against a fingerprint-detecting pad, and in the latter case by entering a personal identification code such as a Personal Identification Number (PIN).

There are a number of disadvantages associated with the known identification methods. In the first place, it is bothersome to the user to enter a code or to place his fingertip against the fingerprint-detecting pad whenever he wants to retrieve his own stored weight data and/or store new weight data. In the second place, mistakes may be made and new weight data may be stored with the wrong code if personal identification codes are used.

It is an object of the present invention to provide a method of identifying a user of a weighing device, wherein it is not necessary that the user actively establishes his identity.

According to the present invention, this object is achieved by a system according to the invention, comprising means for detecting a distribution of pressures exerted by at least one foot of the person on a surface, means for storing data of a number of persons, said data comprising a detected pressure distribution pattern and an associated person identification code, and means for comparing a detected pressure distribution pattern with stored pressure distribution patterns until a match of pressure distribution patterns is found. The present invention is based on the recognition that every person possesses a unique weight distribution, resulting in a unique pressure distribution pattern which can be measured through at least one foot. The distribution of the pressures exerted by the foot of the user is detected. The pressure distribution pattern can then be used to identify the user by comparing the currently detected pressure distribution pattern with previously detected pressure distribution patterns associated with specific users. This system is especially advantageous for use with a weighing device, because users of a weighing device need to stand on the device anyway for determining their weights. In this manner no further actions are required of the user in order to establish his identity. The system according to the invention, however, may also be advantageously applied in, for example, a mat on which a person stands before entering a room, or a house. In this manner the identity of a person standing on the mat can be easily detected, which may be used, for example, to activate certain personal settings in the room, or the house.

The invention will now be explained in greater detail with reference to the Figures, in which similar parts are indicated by the same reference signs, and in which:

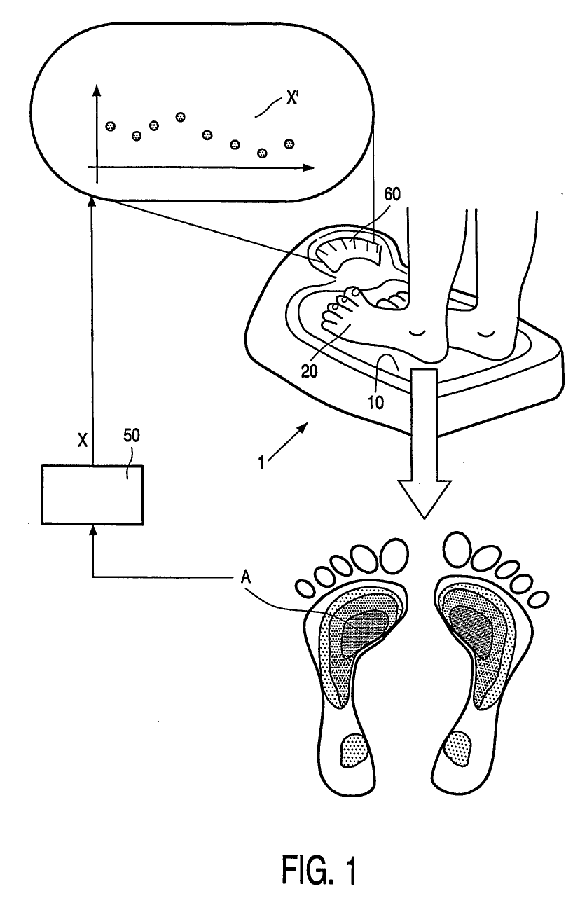

FIG. 1 diagrammatically illustrates the way in which the invention generally works;

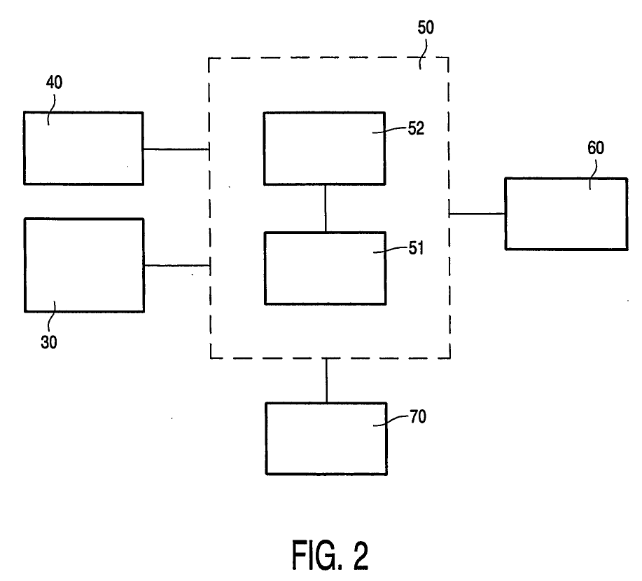

FIG. 2 diagrammatically shows components of a weighing device according to the invention; and

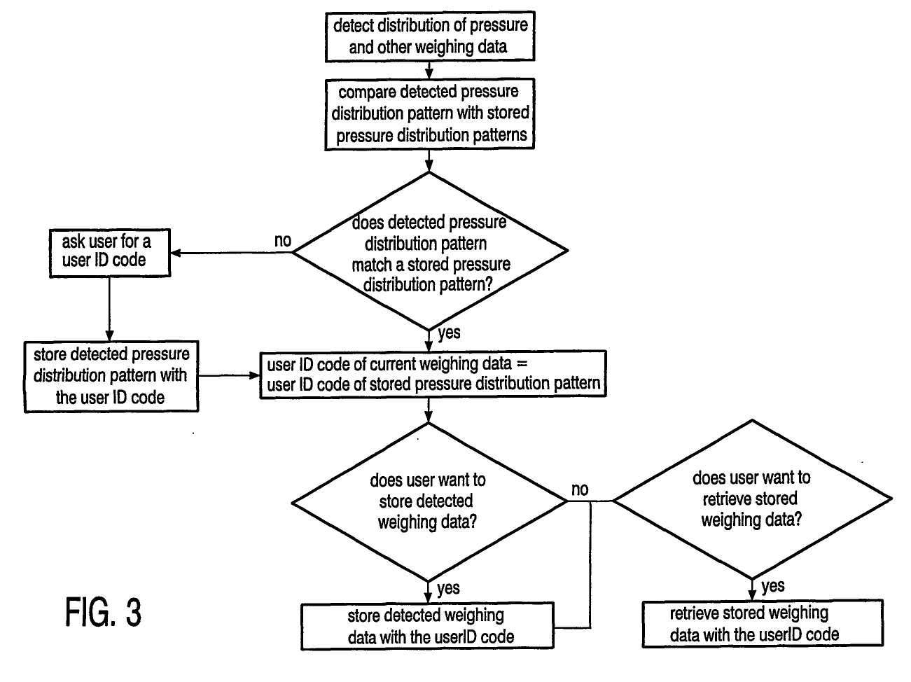

FIG. 3 is a flowchart of an algorithm which may be applied when carrying out the method according to the invention.

FIG. 1 diagrammatically shows a weighing device 1 having a weighing platform 10 for receiving the feet 20 of a user, and FIG. 2 diagrammatically shows components of this weighing device 1. There are many possibilities for the exterior of the weighing device 1, but it is important that the user should be able to stand on it. The weighing device 1 may be constructed as a pair of bathroom scales, but may, for example, alternatively be constructed as professional scales for use in a hospital or (diet) clinic. The weighing device 1 may comprise any kind of suitable weight-detecting means 30 for determining the weight of the user.

According to an important aspect of the invention, the weighing device 1 comprises pressure distribution detecting means, preferably in the form of a matrix sensor 40, for detecting the distribution of pressures, exerted by the feet 20 of the user. In this context, the term “matrix sensor” is utilized to indicate a sensor which is capable of performing detections in at least two different positions. Usually, a matrix sensor comprises many detecting positions, far more than two. This is also true for the matrix sensor 40 which is part of the weighing device 1.

Preferably, the matrix sensor 40 is constructed as a layer implemented in the weighing platform 10. In a possible embodiment, the matrix sensor 40 comprises a matrix of electrical contacts, wherein a rubber having a pressure-dependent conductivity is placed between these contacts.

Besides the weight-detecting means 30 and the pressure distribution detecting means 40, the weighing device 1 may comprise other kinds of detecting means, for example for detecting the percentage of fat mass of a user.

In practice, the weight-detecting means 30 and the pressure distribution detecting means 40 may be integrated in a single sensor. For example, it is possible to utilize the above-described matrix sensor 40 for detecting the pressure distribution as well as the weight, wherein the weight is derived from the detected pressure distribution pattern A, as the sum of the pressures being detected in the detecting positions is indicative of the weight.

The weighing device 1 further comprises a processor 50 for processing signals which are generated by the weight-detecting means 30 and the matrix sensor 40. FIG. 1 diagrammatically indicates that the pressure distribution pattern A detected by the matrix sensor 40 serves as input data for the processor 50, which determines the identity X of the current user and transmits weight data of this specific user, for example his weight-history X′, to a display 60. Preferably, the display 60 is positioned at a level with the weighing platform 10, so that the weighing device 1 can be compact and flat. Alternatively, the display 60 may be positioned at eye level of the user, unlike what is shown in FIG. 1.

In the following, a possibility of an algorithm laid down in the processor 50 is described. A flowchart of this algorithm is shown in FIG. 3 by way of illustration.

When a user has placed his feet 20 on the weighing device 1, the weight-detecting means 30 and the matrix sensor 40 are activated by the weight of the user. The weight-detecting means 30 transmit a signal representing the weight of the user to the processor 50, whereupon the matrix sensor 40 transmits a signal representing the distribution of pressures, exerted by the feet 20 of the user to the processor 50.

The processor 50 comprises a storage medium 51 in which weight data of different users are stored. All weight data of a specific user are coupled to a specific user ID code (D=identification). The stored weight data comprise weight distribution patterns A, B, C of the users. Advantageously, date and possibly also time of the weight data are also stored in the storage medium 51, so that each user can choose to have his weight history displayed on the display 60.

In order to be able to identify the current user, the processor 50 comprises a comparator 52 for comparing the pressure distribution pattern A as detected by the matrix sensor 40 with the pressure distribution patterns A, B, C as stored in the storage medium 51.

The comparing action may be performed in any suitable way. For example, images of two pressure distribution patterns are compared, and differences between the images are translated into a vector, the images being positioned such that the differences and consequently the vector are as small as possible. In such a case, the size of the vector can be utilized to determine whether there is a match of pressure distributions patterns or not.

There are two possible outcomes of a comparing action performed by the comparator 52; a first possible outcome being that a match of pressure distribution patterns is found, and a second possible outcome being that no match of pressure distribution patterns is found.

In the case of the first possible outcome, the processor 50 couples the current weight data to the user ID code X which is associated with the matching pressure distribution pattern A. Depending on current personal wishes of the user, the current weight data may be stored in the storage medium 51 with the user ID code X and/or stored weight data X′ with the user ID code may be retrieved from the storage medium 51 and displayed by means of the display 60. The user can communicate his wishes to the processor 50 by means of an input device 70. Some personal preferences may already have been laid down in the storage medium 51, for example personal preferences regarding the way in which retrieved weight data should be presented on the display 60.

In the case of the second possible outcome, the processor 50 offers the possibility of entering a user ID code X, and probably some additional data, for example the above-mentioned personal preference regarding the way in which weight data should be displayed on the display 60. When the user has entered a user ID code X by means of the input device 70, the processor 50 couples this user ID code X to the detected pressure distribution pattern A and stores these data in the storage medium 51. Furthermore, the other current weight data are also coupled to the newly entered user ID code. The user can then choose to have these weight data stored in the storage medium 51 as well.

An important advantage offered by the weighing device 1 is that there is no need for the user to actively establish his identity once he has utilized the weighing device 1 for a first time, and data regarding his specific pressure distribution pattern A and his user ID code X are stored in the storage medium 51. When the user has placed his feet 20 on the weighing platform 10 of the weighing device 1, the matrix sensor detects the distribution of pressures, exerted by his feet 20, and the comparator 52 compares the detected pressure distribution pattern A with previously stored pressure distribution patterns A,B,C. At some point in this process, the detected pressure distribution pattern A will match the stored pressure distribution pattern of the user, and the user ID code X of the user is found. Thus, according to the invention, identification of the user is performed automatically through detection of the distribution of pressures, exerted by his feet 20.

The algorithm according to which the processor 50 processes the weight data may be such that weight data of a user are only displayed when the user is automatically identified, or when the user manually enters the user ID code. In this way the privacy of the individual users of the weighing device 1 can be guaranteed.

It will be clear to a person skilled in the art that the scope of the present invention is not limited to the examples discussed in the foregoing, but that several amendments and modifications thereof are possible without deviating from the scope of the invention as defined in the attached claims. The system according to the invention may, for example, also be advantageously integrated into a specific area on the floor on which a person stands. In this manner the identity of a person standing on said area can be easily detected, which may be used, for example, to activate certain personal settings in a room, or to allow entrance to a room. For this purpose, not only pressure distribution patterns of the bare feet, but also pressure distribution patterns of feet covered by shoes may be used by the system according to the invention to identify a person.

1. System for identifying a person, comprising:
means for detecting a distribution of pressures, exerted by at least one foot (20) of the person on a surface,
means for storing data of a number of persons, said data comprising a detected pressure distribution pattern (A,B,C) and an associated person identification code (X,Y,Z), and
means for comparing a detected pressure distribution pattern (A) with stored pressure distribution patterns (A,B,C) until a match of pressure distribution patterns is found.

2. System according to claim 1, characterized in that the pressure distribution detecting means comprise a matrix sensor (40).

3. System according to claim 1 characterized in that said surface comprises a platform (10) for receiving at least one foot (20) of the person, the pressure distribution detecting means (40) comprising a layer implemented in the platform (10).

4. System according to claim 1, characterized in that the pressure distribution detecting means (40) comprise a matrix of electrical contacts, with a rubber having a pressure-dependent conductivity being placed between these contacts.

5. System according to claim 1, characterized in that the means for storing detected pressure distribution patterns comprise a processor (50) having a storage medium (51).

6. System according to claim 5, characterized in that the processor (50) further comprises a comparator (52) for comparing a detected pressure distribution pattern (A) with the stored pressure distribution patterns (A,B,C).

7. System according to claim 1, characterized in that it comprises a system for identifying a user of a weighing device (1).

8. A method of identifying a person, characterized in that said method comprises the steps of:
detecting a distribution of pressures, exerted by at least one foot (20) of the person on a surface,
storing data of a number of persons, said data comprising a detected pressure distribution pattern (A,B,C) and an associated person identification code (X,Y,Z), and
comparing a detected pressure distribution pattern (A) with stored pressure distribution patterns (A,B,C), until a match of pressure distribution patterns is found.

9. A method as claimed in claim 8, characterized in that said method is a method of identifying a user of a weighing device (1).
